(19) United States
(12) Patent Application Publication
(10) Pub. No.: US 2002/0086717 A1
(43) Pub. Date: Jul. 4, 2002

(54) On hand-free receiver architecture of a cellular phone

(76) Inventor: Ming-Yuan Lai, Hsintien City (TW)

Correspondence Address: David E. Doughtery, DENNISON, SCHULTZ & DOUGHTERY, 612 Crystal Square 4, 1745 Jefferson Davis Highway, Arlington, VA, 22202, US

(21) Appl. No.: 09/983,372

(22) Filed: Oct. 24, 2001

(30) Foreign Application Priority Data
Jan. 4, 2001 (TW) 90200138

(51) Int. Cl. H04M 1/00

(52) U.S. Cl. 455/569; 455/557

(57) ABSTRACT

An improvement on hand-free receiver architecture of a cellular phone, having an adequately sized shielding body; in the outside of shielding body a connecting part is configured, and in the inside of shielding body a battery and a circuit board are configured; provided in the periphery of shielding body are a power switch connected to the circuit board, a microphone, an earphone hole, a power input hole, and an antenna. The connecting part is used to tie the shielding body with a speaker device of the cellular phone so that a sound wave signal through the microphone is changed into an electrical signal, and an information through a signal processing circuit, as the shielding body coupled to the circuit board, is changed into a radio wave (frequency-modulated (FM) wave or amplitude-modulated (AM) wave, and finally the radio wave is transmitted out via the antenna and, therefrom, the information is output through the receiving of radio to implement a high performance of hand-free receiver.

### FIELD OF THE INVENTION

The present invention relates to an improvement on hand-free receiver architecture of a cellular phone, wherein a received information may be changed into a radio wave (frequency-modulated (FM) wave or amplitude-modulated (AM) wave), and next a received information may be audibly revealed from a radio speaker. In particular, the invention is equivalently applied to any other radio to more easily answer a phone with the hand-free receiver.

### PRIOR ART

A general structure of hand-free receiver device of cellular phone is shown in FIG. 7, wherein a circuit and a speaker 711 are provided in a lighters socket 7 of a plug 71, and provided in a side of the lighters socket 7 is an earphone socket 712 for a joint 721 of an earphone 72; the other side of the lighters socket 7 is, with a lead, connected to a connector 73 to link to a cellular phone; a microphone 74, when used, is herein used to couple the connector 73 with a cellular phone, and the plug 71 of lighters socket 7 is inserted into an insertion hole on a vehicle to supply the power and reach the purpose of using a phone with a hand-free receiver in driving. However, below shown are some defects of the conventional hand-free receiver of cellular phone in practical use:

1. The device may only be connected to a lighter insertion hole of a vehicle, which is strictly confined in the vehicle use.

2. A said speaker is provided in a socket and the socket, in use, is inserted in a lighters insertion hole of a vehicle; however, said insertion hole is generally provided in a lower position, wherein the speaker is located so far from the driver that the driver cannot clearly hear the speaker, and normal cars (apart from top ones) have no sound-proof performance, wherein much noise out of engine and external to a vehicle is a serious factor to affect the performance.

3. Seeing that a speaker is located far from a driver, in use, an earphone generally serves as an auxiliary part for improvement; however, the driver with an earphone, while driving, doesn't feel good and stays in danger, losing the normal sense of hearing.

4. With large volume and many auxiliaries, said device occupies parts of space in a car and is inconvenient to carry.

In view of improving the aforesaid defects of the hand-free receiver of conventional cellular phone, it would be desirable to implement a high-performance device designed with the professional technology and practical experience in the mobile periphery equipment as well as the related electronics products design for consumers' easy use.

### SUMMARY OF THE INVENTION

The present invention is to provide an improvement on hand-free receiver architecture of a cellular phone. A signal processing circuit provided within the device changes received information into a radio wave (frequency-modulated (FM) wave or amplitude-modulated (AM) wave), and a radio is used to receive said information and then send it out to function as a hand-free receiver.

The invention is to further provide a mechanism of easy installation and a user-friendly device, an improver of hand-free receiver architecture of a cellular phone.

The invention is to further provide a radio speaker used to work as a self-megaphone for the purpose of decreasing the volume of hand-free receiver architecture of a cellular phone.

The invention is to further provide an improver of hand-free receiver architecture of a cellular phone by way of an earphone inserted to function as a simply secret tele-communication.

To reach the aforesaid purpose, the present invention provides an adequately sized shielding body; in the outside of shielding body a connecting part is configured, and in the inside of shielding body a battery and a circuit board are configured; provided in the periphery of shielding body are a power switch connected to the circuit board, a microphone, an earphone hole, a power input hole, and an antenna. The connecting part is used to tie the shielding body with a speaker device of the cellular phone so that a sound wave signal through the microphone is changed into an electrical signal, and an information through a signal processing circuit, as the shielding body coupled to the circuit board, is changed into a radio wave (frequency-modulated (FM) wave or amplitude-modulated (AM) wave, and finally the radio wave is transmitted out via the antenna and, therefrom, the information is output through the receiving of radio to implement a high performance of hand-free receiver.

The following figures and detailed description of the preferred embodiments will more clearly demonstrate these and other objects and advantages of the invention.

### BRIEF DESCRIPTION OF DRAWINGS

FIG. 1 shows a three-dimensional outline according to an embodiment of the invention;

FIG. 2 shows elements decomposed according to an embodiment of the invention;

FIG. 3 shows a circuit diagram according to an embodiment of the invention;

FIG. 4 shows an illustrative drawing of a cellular phone attached with a clip according to an embodiment of the invention;

FIG. 5 shows an illustration of a device used in a vehicle according to an embodiment of the invention;

FIG. 6 shows an illustration of a device used indoors according to an embodiment of the invention;

FIG. 7 shows a three-dimensional outline of a hand-free receiver of conventional device.

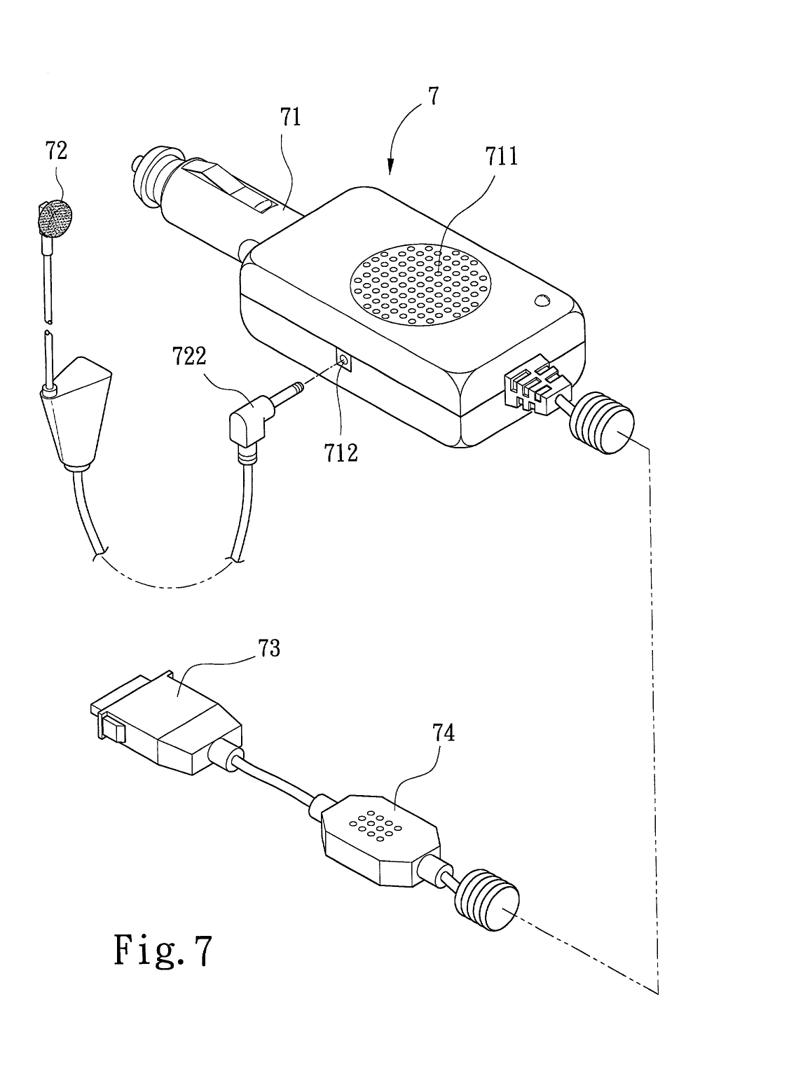

### DETAILED DESCRIPTION OF THE PREFERRED EMBODIMENT

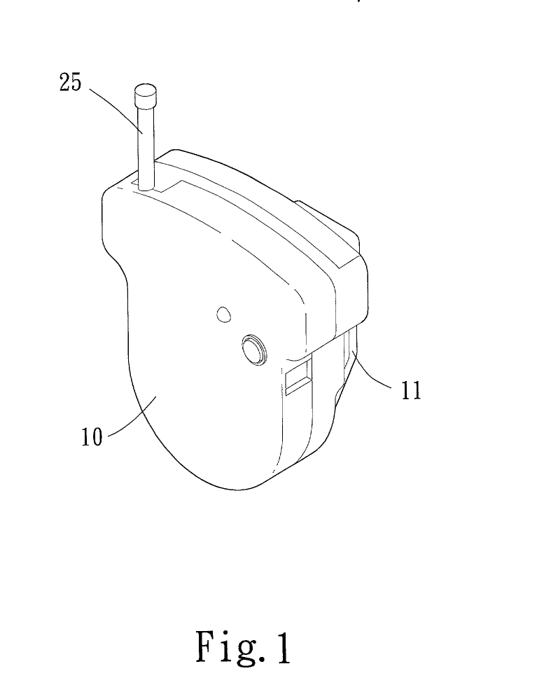

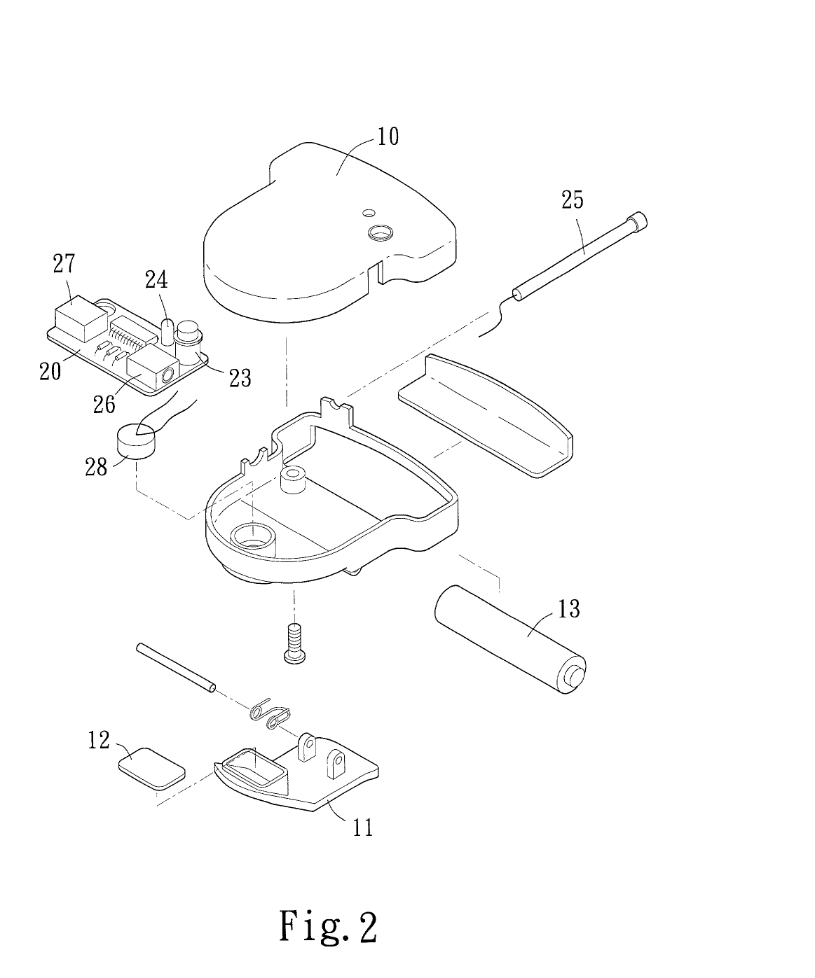

Referring to FIG. 1 and FIG. 2, the present invention generally provides an adequately sized shielding body 10; provided in the back side of the shielding body 10 is a clip part 11; provided both in the opening of clip 11 and in the corresponding clip part of shielding body 10 is a soft pad, wherein individually installed in a suitable position on the shielding body 10 are a microphone, a power input insertion hole, an earphone hole, an antenna hole, a switch hole, and a power indicating lamp hole, and within the shielding body, a battery 19 and a circuit board 20.

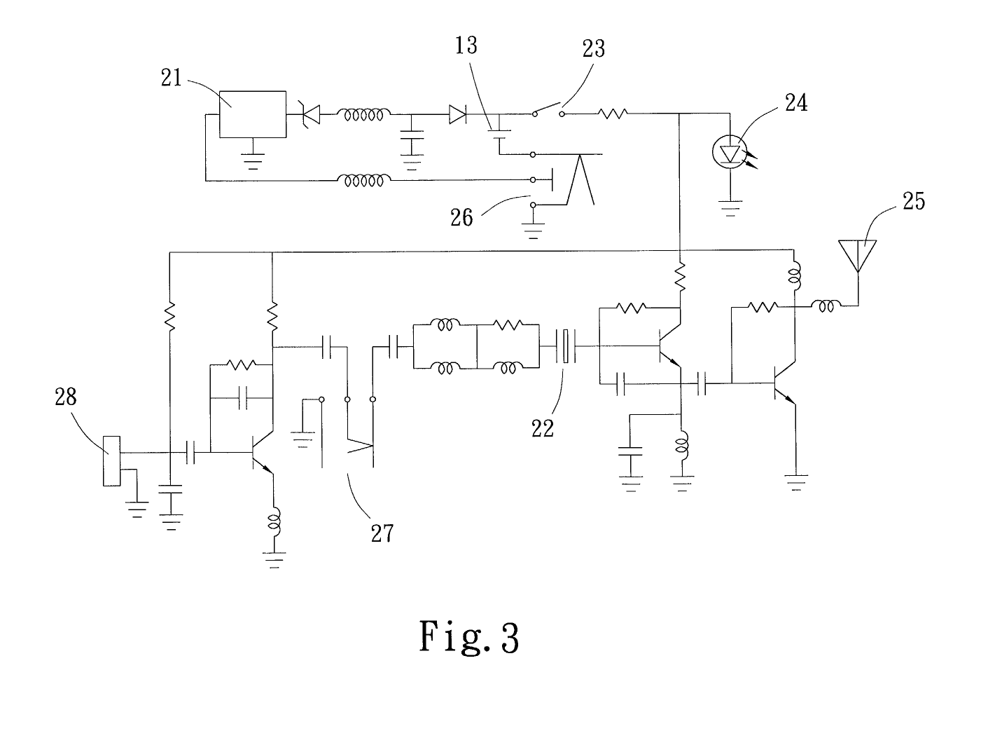

Organized into a signal processing circuit on a circuit board 20 are multi-resistors, an inductor, a transistor, a diode, a voltage-regulated IC 21, a quartz oscillator 22, a power switch 23, an LED 24, an antenna 25, a power input outlet 26, an earphone socket 27, and a microphone 28, as shown in FIG. 3, wherein the above-shown power switch 23, LED 24, antenna 25, power input socket 26, earphone socket 27 and microphone 28 are, for the assembly of the invention, respectively installed in a switch hole of the shielding body 10, a power indicating lamp hole, an antenna hole, a power input hole, an earphone hole, and a microphone hole.

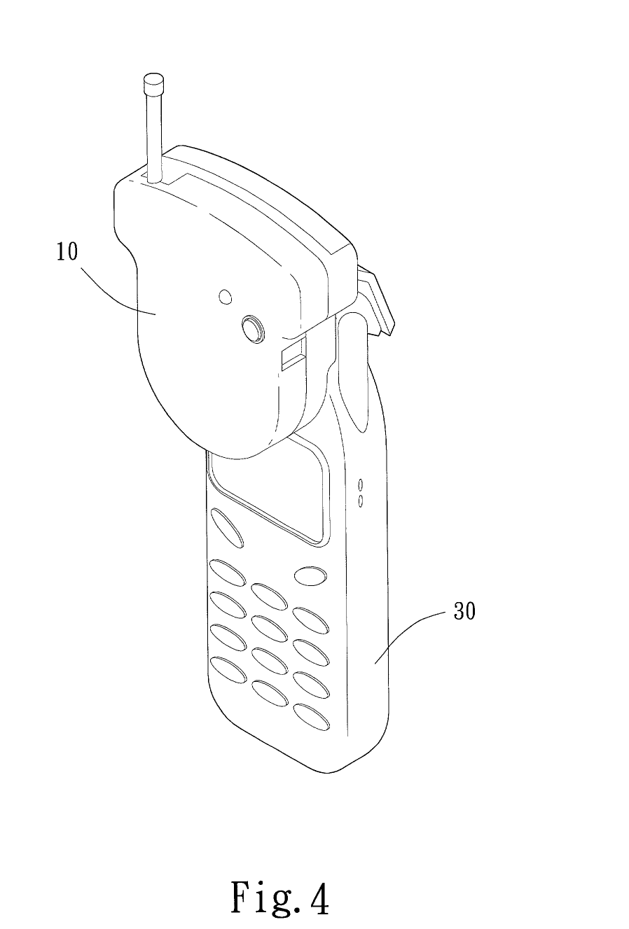

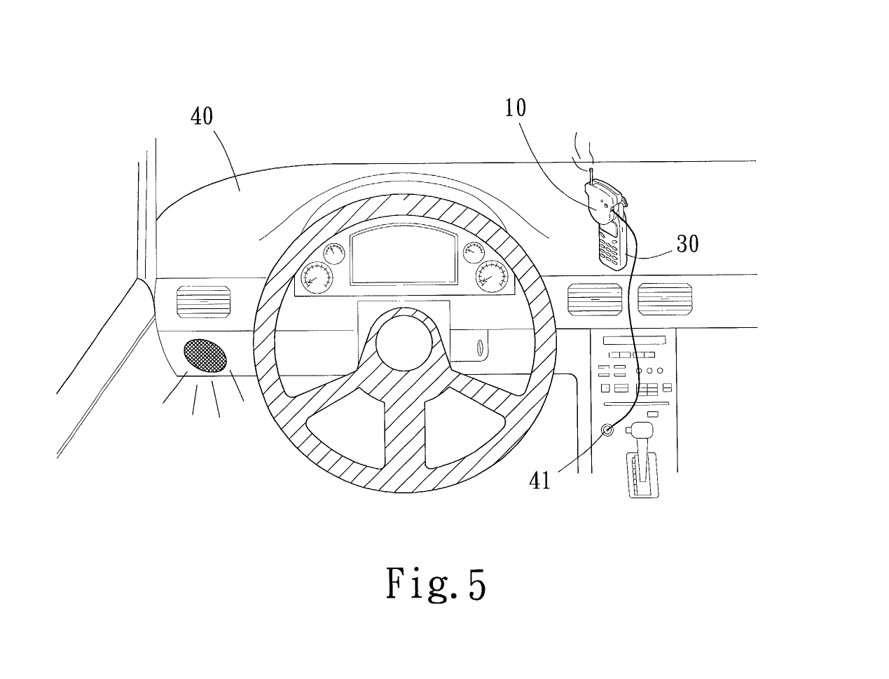

Referring to FIG. 4 and FIG. 5, a clip part 11 provided in the back side of shielding body 10 of the invention is used to clip a voicing device 31 of a cellular phone 30, which makes a microphone 28 stacked on the voicing device; a soft pad 12 is fixed in both a clip part 11 and a correspondingly clipped area of shielding body to prevent a cellular phone 30 from being damaged when clipped. A battery 19 built in the shielding body 10 may regularly supply the circuit 20 with power to benefit users when staying in a site without a power supply. When a power switch 23 is switched ON, a circuit board 20 turns ON and an LED lights, while a voltage-regulated IC 21 provides a regular voltage, in which a signal introduced from a microphone 28 is amplified by a transistor and meanwhile a quartz oscillator 22 oscillates a carrier wave loading an amplified signal and sends out said frequency-modulated wave through an antenna 25. Users staying in vehicles 40 only locate the cellular phone 30 in a proper site; the microphones of the current cellular phones have a wide-range (around 80 cm) acoustics so that said information may be sent out by way of the radio and through the speaker, of a vehicle, to reach the performance of hand-free receiver.

Furthermore, if a battery 19 runs out of power, a power input outlet 26 is additionally provided in the shielding body 10 to allow a power plug with a lighters socket 41 to be plugged for the other supply source of electricity. If what a user talks is not expected to be heard by the other passengers in the car, a power switch 23 can be switched OFF, which disables the circuit to work, and a normal earphone can be inserted into an earphone socket 27 so that the cellular phone forms a hand-free receiver structured with an earphone line.

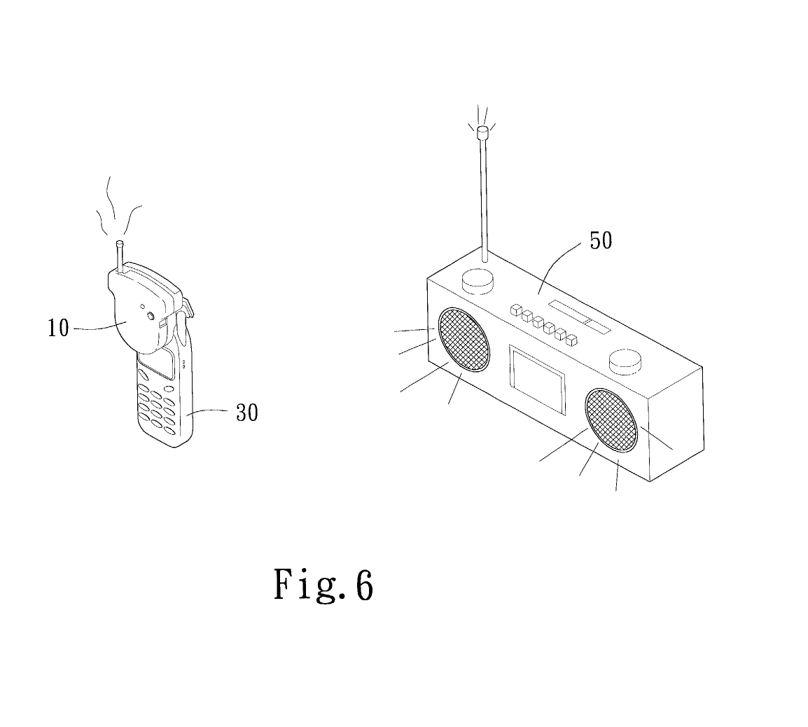

Still referring to FIG. 6, if a user is generally situated indoors, a normal radio 50 may be used as a receiver of a cellular phone 30 to receive the information sent by the cellular phone 30 and to transmit out the information through its speaker for the use of hand-free receiver architecture not confined in a car 40 but widened in range.

Below shown are the advantages of the improved hand-free receiver of cellular phone of the invention:

1. The volume of the device being decreased, a speaker of a radio is used as a megaphone of the device.

2. For the purpose of easy use and cost-saving consideration, the invention may be directly applied, not additionally through any connection, to a voicing device of a cellular phone.

3. A signal processing circuit is used to change a voice information into a radio wave (frequency-modulated (FM) wave or amplitude-modulated (AM) wave) so that once only a radio is provided, the performance of hand-free receiver can reach; therefore, the use in a car is not the only one.

4. The invention may transmit a sound wave signal using a radio speaker, and a general earphone also may be inserted to form a hand-free receiver architecture to benefit the invention with a secret tele-communication function.

5. The architecture of the invention is directly applied to a voicing device of a cellular phone, suitable to any other cellular phone to improve the conventional hand-free receiver architecture of resulting into a problem of a cellular phone only applicable to a connector for connection.

From the description mentioned above, an improvement on hand-free receiver architecture of a cellular phone of the invention, for use, is a newly improved invention applicable to industries, not confined by any place or any phone model, and the invention having not yet exposed in any other publication, a new patent may be legally applied for an application category.

While the invention has been described with reference to preferred embodiments, the description is illustrative of the invention and not to be construed as limiting the invention. Various modifications and applications may occur to those skilled in the art without departing from the true spirit and scope of the invention as defined in the appended claims.

1. An improvement on hand-free receiver of a cellular phone, including an adequately sized shielding body, in the outside of the shielding body a connecting part being configured to connect a voicing device of a cellular phone, while in the inside of shielding body a battery and a circuit board provided therein; in the periphery of the shielding body being a power switch connected to the circuit board, a microphone, an earphone hole, a power input hole, and an antenna; thereby when a cellular phone receives a sound signal externally dispatched by any other cellular phone, a sound wave signal through the microphone is thereof changed into an electrical signal, and an information through a signal processing circuit is changed, as the shielding body coupled to the circuit board, into a radio wave, and finally the radio wave is transmitted out via the antenna.

2. An improvement on hand-free receiver of a cellular phone of claim 1, wherein organized into a signal processing circuit are multi-resistors, a capacitor, an inductor, a transistor, a diode, more than one voltage-regulated ICs and a quartz oscillator.

3. An improvement on hand-free receiver of a cellular phone of claim 1, wherein said radio wave is a frequency-modulated (FM) wave.

4. An improvement on hand-free receiver of a cellular phone of claim 3, wherein the operating frequency of said FM wave ranges from 87.5 MHz to 109.0 MHz.

5. An improvement on hand-free receiver of a cellular phone of claim 1, wherein said radio wave is an amplitude-modulated (AM) wave.

6. An improvement on hand-free receiver of a cellular phone of claim 5, wherein the operating frequency of said AM wave ranges from 530 KHz to 1600 KHz.

7. An improvement on hand-free receiver of a cellular phone of claim 1, wherein said connection part is a back clip.

8. An improvement on hand-free receiver of a cellular phone of claim 7, wherein the clipping part of said back clip is provided with a soft pad to prevent a cellular phone from being damaged when clipped.

9. An improvement on hand-free receiver of a cellular phone of claim 1, wherein a radio is used as a receiver to receive a radio wave switched and transmitted by said signal processing circuit.
